(19) United States
(12) Patent Application Publication
(10) Pub. No.: US 2007/0239746 A1
(43) Pub. Date: Oct. 11, 2007

(54) Visual merge of portlets

(75) Inventors: Eric L. Masselle, Raleigh, NC (US); David B. Lection, Raleigh, NC (US); Anuphinh Phimmasorn, Durham, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/391,882

(22) Filed: Mar. 29, 2006

(51) Int. Cl. G06F 7/00

(52) U.S. Cl. 707/101

(57) ABSTRACT

The present invention provides visual merging of portlets associated by a common key of data (e.g., a common Click-to-Action key). A method in accordance with an embodiment of the present invention includes: providing a plurality of portlets having a common key of data; and merging at least two of the plurality of portlets into a merged portlet based on the common key of data.

### BACKGROUND OF THE INVENTION

1. Field of the Invention

The present invention generally relates to portlets, and more specifically relates to the visual merge of portlets associated by a common key of data (e.g., a common Click-to-Action key).

2. Related Art

WebSphere® Portal, available from International Business Machines, provides a feature called “Click-to-Action” (C2A). The C2A function allows portlets to perform data collaborations based on a common key of data. For example, as illustrated in FIG. 1, a first portlet 10 displays a table 12 containing a list of employee ID numbers. The portlet 10 is configured to publish (make available to other C2A enabled portlets) the employee ID numbers contained in the table 12 (i.e., the common key of data=employee ID number). A second portlet 20 displays a table 22 having a first column 24 containing employee ID numbers and a second column 26 containing associated employee salary information. A third portlet 30 displays a table 32 having a first column 34 containing employee ID numbers and a second column 36 containing associated employee benefit information. The second portlet 20 uses the employee ID numbers to display associated employee salary information. Similarly, the third portlet 30 uses the employee ID numbers to display associated employee benefit information.

When the first portlet 10 publishes 38 a new set of employee ID numbers using the C2A function, the table 22 in the second portlet 20 is updated to display employee salary information associated with the new employee ID numbers, while the table 32 in the third portlet 30 is updated to display employee benefit information associated with the new employee ID numbers. This coordinated behavior is achieved through dynamic selection, by the user, or through static ‘wiring’ of the portlets, which makes the coordinated behavior automatic. Additional information regarding the C2A function can be found, for example, in Patent Application Publication Nos. US 2004/0090969 A1, US 2004/0243577 A1, and US 2005/0175015 A1, which are incorporated herein by reference. While this coordinated behavior can be useful, the user must still switch views between the portlets 20, 30 in order to collect the employee salary information and employee benefit information associated with each individual employee ID number. This is especially burdensome when the portlets 20, 30 are located on different portal pages.

### SUMMARY OF THE INVENTION

The present invention provides visual merging of portlets associated by a common key of data (e.g., a common Click-to-Action (C2A) key).

A first aspect of the present invention is directed to a method for merging portlets, comprising: providing a plurality of portlets having a common key of data; and merging at least two of the plurality of portlets into a merged portlet based on the common key of data.

A second aspect of the present invention is directed to a system for merging portlets, comprising: a plurality of portlets having a common key of data; and a system for merging at least two of the plurality of portlets into a merged portlet based on the common key of data.

A third aspect of the present invention is directed to a program product stored on a computer readable medium for merging portlets, the computer readable medium comprising program code for performing the steps of: providing a plurality of portlets having a common key of data; and merging at least two of the plurality of portlets into a merged portlet based on the common key of data.

A fourth aspect of the present invention is directed to a method for deploying an application for merging portlets, comprising: providing a computer infrastructure being operable to: provide a plurality of portlets having a common key of data; and merge at least two of the plurality of portlets into a merged portlet based on the common key of data.

The illustrative aspects of the present invention are designed to solve the problems herein described and other problems not discussed

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative Click-to-Action (C2A) scenario in accordance with the related art.

FIG. 2 depicts an illustrative merging of the data of two portlets associated by a common key of data in accordance with an embodiment of the present invention.

FIG. 3 depicts an illustrative merging of the data of a plurality of portlets associated by a common key of data and located on the same portal page in accordance with an embodiment of the present invention.

FIG. 4 depicts an illustrative merging of the data of a plurality of portlets associated by a common key of data and located on different portal pages in accordance with an embodiment of the present invention.

FIGS. 5-6 depict the use of visual indicators to indicate the mergability of portlets in accordance with an embodiment of the present invention.

FIG. 7 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention provides visual merging of portlets associated by a common key of data (e.g., a common Click-to-Action (C2A) key). In particular, the present invention provides for the merging of two or more portlets, into a single display, where the portlets are logically joined by a common key of data. The portlets to be merged can originate on the same or separate portal pages.

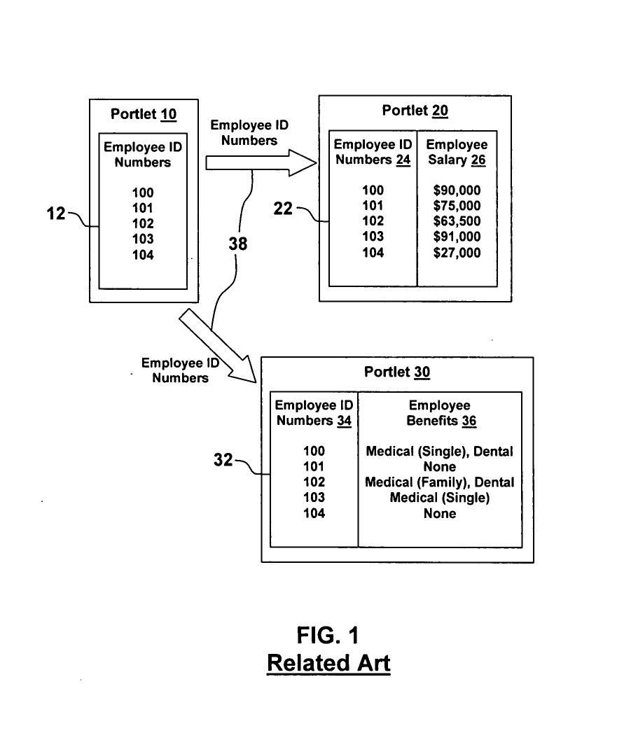

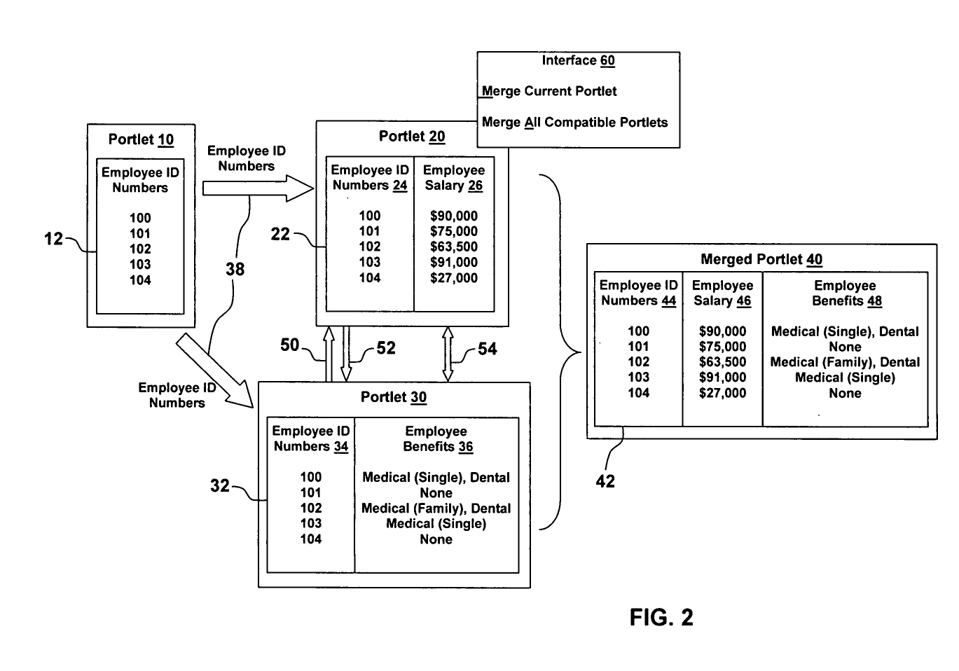

In accordance with the present invention, using the C2A scenario displayed in FIG. 1, the content of the portlets 20, 30 can be merged to form a single portlet, such as the single merged portlet 40 depicted in FIG. 2. In this example, the merged portlet 40 displays a table 42 having a first column 44 containing employee ID numbers, a second column 46 containing associated employee salary information, and a third column 48 containing associated employee benefit information. The merged portlet 40 contains a correlated display of data, correlated by the common key of data (i.e., employee ID number) that was communicated using C2A. The specific arrangement of the data in the merged portlet 40 can be determined in advance by a portlet designer, determined on-the-fly based on predetermined rules, determined by a user (e.g., via a user preference dialog), or determined in any other suitable manner. To this extent, the arrangement of the data in the merged portlet 40 shown in FIG. 2 is not intended to be limiting; many other arrangements of data are possible.

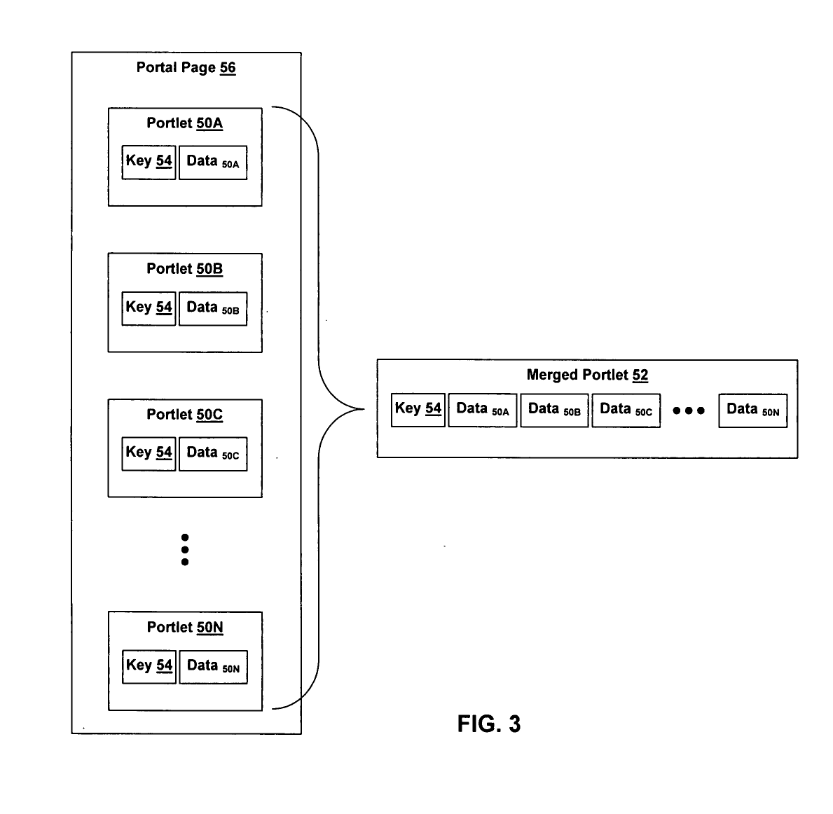

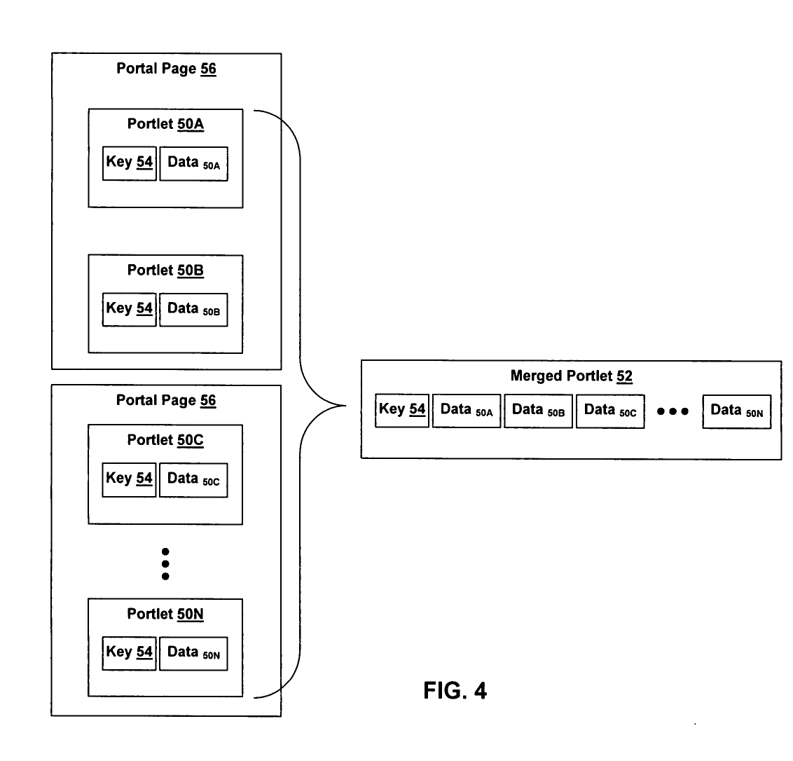

Although the above example depicts the merging of the data of two portlets, the present invention can be used to merge the data of any number of portlets that are logically joined by a common key of data. The merging of the data contained in N portlets 50A-50N (N≧2) into a single merged portlet 52, based on a common key of data 54, is depicted in FIG. 3. The N portlets 50A-50N can be located on the same portal page 56, as shown in FIG. 3, or can be located on different portal pages 56, as shown in FIG. 4.

Many techniques can be used to achieve/initiate the portlet merge. For instance, when one portlet is dragged to another portlet, data for the two portlets is merged, and the two portlets are replaced with a single portlet that displays the merged data, correlated by a common key of data. Such dragging (and the direction thereof) is represented by the block arrows 50, 52 in FIG. 2. Further, multiple portlets (which can be located on the same or different portal pages) can be wired together in a C2A fashion, such that the merging action occurs automatically. Such wiring is represented by the double-ended block arrow 54 in FIG. 2.

As depicted in FIG. 2, a user can also be presented with merge-related command(s) via an interface 60 (e.g., a window, pop-up menu, dialog box, etc.) or other selection mechanism. A command can be chosen by the user to selectively merge the data in a plurality of compatible portlets (e.g., portlets 20, 30) that are logically joined by a common key of data (e.g., employee ID number). For instance, the interface 60 could present a command such as “Merge Current Portlet” to the user. If selected, the “Merge Current Portlet” command could result in the merging of the portlets 20, 30 into the merged portlet 40, as described above. The portlets 20, 30 can be located on the same or different portal pages.

A command such as “Merge All Compatible Portlets” could also be provided in the interface 60. If selected, the “Merge All Compatible Portlets” could result in the merging of the portlets 20, 30 into the merged portlet 40, as described above, as well as the merging of all other compatible portlets (if any) based on their associated common key of data. For example, if portlets A, B, and C have a common key of data D1, and portlets D and E have a common key of data D2, selection of the “Merge All Compatible Portlets” command would result in the formation of a first merged portlet ABC, based on the common key of data D1, and a second merged portlet D2, based on the common key of data D2. Again, the various portlets A-E can be located on the same or different portal pages. The command examples presented above are only representative of the types of commands that could be used to control the portlet merging process provided in accordance with the present invention.

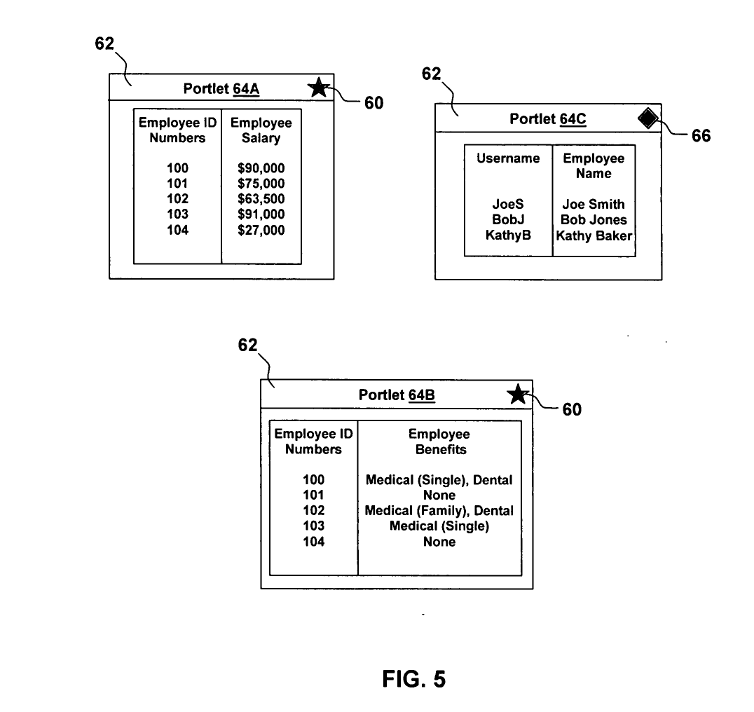

When a portlet can be merged with another portlet, an indicator can be added to the portlets to indicate to a user that a merge is possible. For example, as depicted in FIG. 5, a first visual indicator 60 (e.g., a red star) has been added to the title bars 62 of the portlets 64A, 64B, while a second visual indicator 66 (e.g., a blue diamond) has been added to the title bar 62 of the portlet 64C. To this extent, the visual indicator 60 provides a user with an indication that the portlets 64A, 64B can be merged. Similarly, the visual indicator 66, which is different than the visual indicator 60, provides the user with an indication that the portlet 64C cannot be merged with either of the portlets 64A, 64B. The visual indicators 60, 66 are only illustrative of the many types of indicators that could be provided to inform a user of the merge capabilities of the portlets 64A-C.

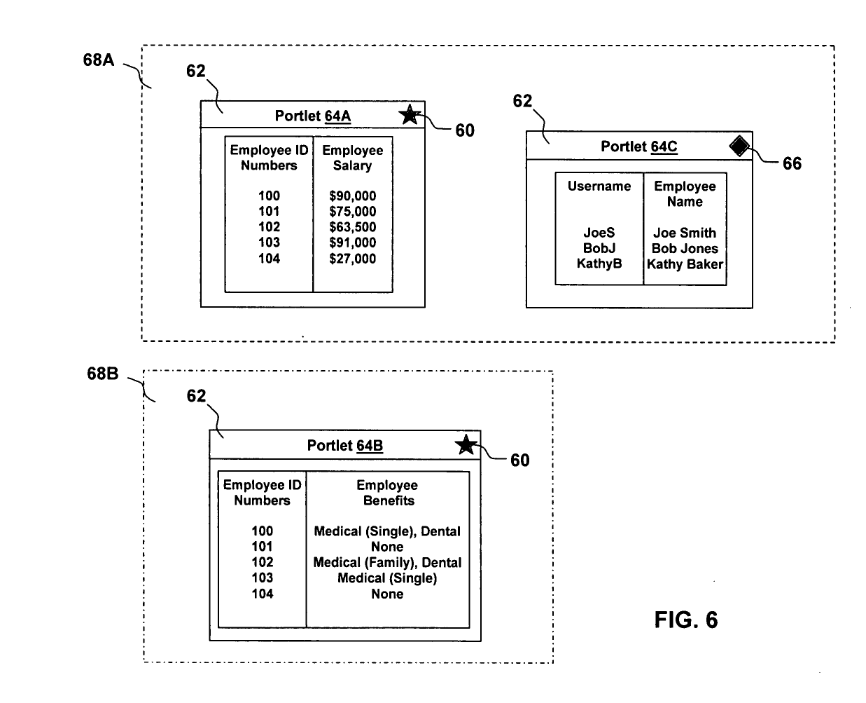

An indicator can be used across portal pages to indicate that portlets located on different portal pages can be merged. For instance, referring to FIG. 6, the portlets 64A and 64C can be located on a first portal page 68A, while the portlet 64B can be located on a second portal page 68B. The visual indicator 60 (e.g., a red star) used on the portlets 64A and 64B provides a user with an indication that the portlets 64A, 64B can be merged.

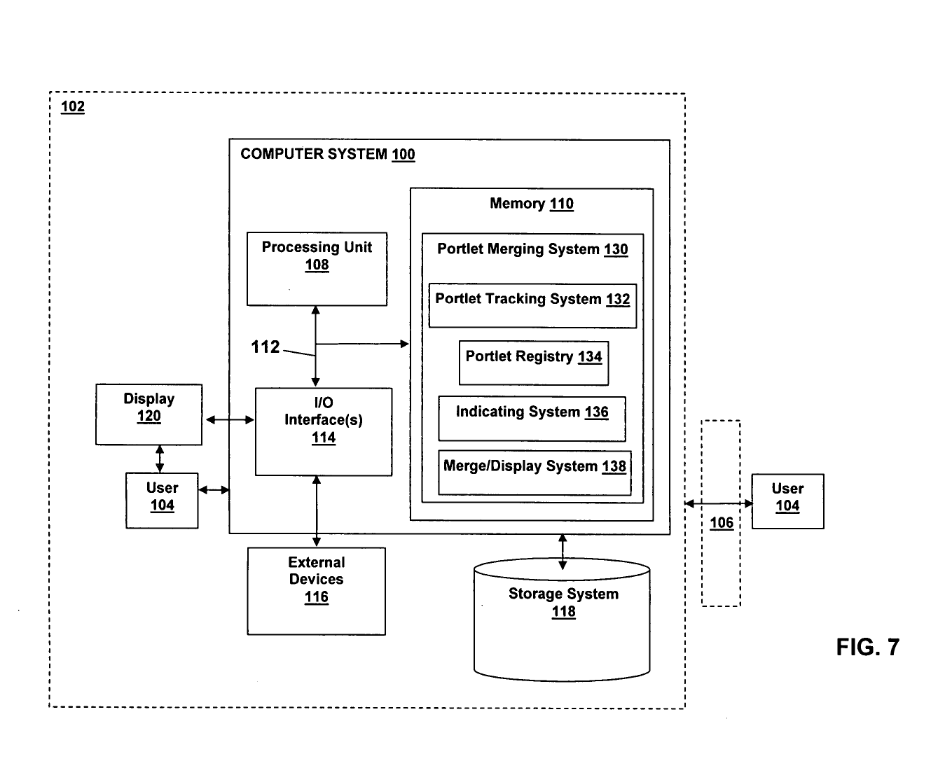

A computer system 100 for providing the visual merging of portlets associated by a common key of data (e.g., a common Click-to-Action (C2A) key) in accordance with an embodiment of the present invention is depicted in FIG. 7. The computer system 100 is provided in a computer infrastructure 102. The computer system 100 is intended to represent any type of computer system capable of carrying out the teachings of the present invention. For example, the computer system 100 can be a laptop computer, a desktop computer, a workstation, a handheld device, a server, a cluster of computers, etc. In addition, as will be further described below, the computer system 100 can be deployed and/or operated by a service provider that provides a service for the visual merging of portlets associated by a common key of data in accordance with the present invention. It should be appreciated that a user 104 can access the computer system 100 directly, or can operate a computer system that communicates with the computer system 100 over a network 106 (e.g., the Internet, a wide area network (WAN), a local area network (LAN), a virtual private network (VPN), etc). In the case of the latter, communications between the computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

The computer system 100 is shown including a processing unit 108, a memory 110, a bus 112, and input/output (I/O) interfaces 114. Further, the computer system 100 is shown in communication with external devices/resources 116 and one or more storage systems 118. In general, the processing unit 108 executes computer program code, such as portal merging system 130, stored in memory 110 and/or storage system(s) 118. While executing computer program code, the processing unit 108 can read and/or write data, to/from the memory 110, the storage system(s) 118, and/or the I/O interfaces 114. The bus 112 provides a communication link between each of the components in the computer system 100. The external devices/resources 116 can comprise any devices (e.g., keyboard, pointing device, display (e.g., display 120, printer, etc.) that enable a user to interact with the computer system 100 and/or any devices (e.g., network card, modem, etc.) that enable the computer system 100 to communicate with one or more other computing devices.

The computer infrastructure 102 is only illustrative of various types of computer infrastructures that can be used to implement the present invention. For example, in one embodiment, the computer infrastructure 102 can comprise two or more computing devices (e.g., a server cluster) that communicate over a network (e.g., network 106) to perform the various process steps of the invention. Moreover, the computer system 100 is only representative of the many types of computer systems that can be used in the practice of the present invention, each of which can include numerous combinations of hardware/software. For example, the processing unit 108 can comprise a single processing unit, or can be distributed across one or more processing units in one or more locations, e.g., on a client and server. Similarly, the memory 110 and/or storage system(s) 118 can comprise any combination of various types of data storage and/or transmission media that reside at one or more physical locations. Further, the I/O interfaces 114 can comprise any system for exchanging information with one or more external devices/resources 116. Still further, it is understood that one or more additional components (e.g., system software, communication systems, cache memory, etc.) not shown in FIG. 4 can be included in the computer system 100. However, if computer system 100 comprises a handheld device or the like, it is understood that one or more external devices/resources 116 (e.g., a display) and/or one or more storage system(s) 118 can be contained within the computer system 100, and not externally as shown.

The storage system(s) 118 can be any type of system (e.g., a database) capable of providing storage for information under the present invention. To this extent, the storage system(s) 118 can include one or more storage devices, such as a magnetic disk drive or an optical disk drive. In another embodiment, the storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in the memory 110 (e.g., as a computer program product) is a portal merging system 130 for providing the visual merging of portlets associated by a common key of data (e.g., a common Click-to-Action (C2A) key), in accordance with the present invention, as described above. The portlet merging system 130 includes a portlet tracking system 132 for identifying portlets that can be merged based on a common key of data. The tracking system 132 can use a portlet registry 134 or the like to keep track of which portlets can be merged. The portal merging system 130 further includes an indicating system 136 for providing a portlet with a visual indicator of its mergability with other portlet(s), and a merge/display system 138 for performing the portlet merge and for displaying the resultant merged portlet.

The present invention can be offered as a business method on a subscription or fee basis. For example, one or more components of the present invention can be created, maintained, supported, and/or deployed by a service provider that offers the functions described herein for customers. That is, a service provider can be used to provide a service for the visual merging of portlets associated by a common key of data, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for merging portlets, comprising:
providing a plurality of portlets having a common key of data; and
merging at least two of the plurality of portlets into a merged portlet based on the common key of data.

2. The method of claim 1, wherein the merged portlet comprises a display of data correlated by the common key of data.

3. The method of claim 1, wherein the common key of data comprises a Click-to-Action key.

4. The method of claim 1, wherein the merging further comprises:
dragging one of the plurality of portlets to another of the plurality of portlets to initiate the merging.

5. The method of claim 1, wherein the merging occurs automatically.

6. The method of claim 1, wherein the merging further comprises:
selecting a command to initiate the merging.

7. The method of claim 1, further comprising:
providing a visual indicator of whether each of the plurality of portlets can be merged.

8. The method of claim 1, wherein the portlets that are merged are located on the same portal page.

9. The method of claim 1, wherein the portlets that are merged are located on different portal pages.

10. A system for merging portlets, comprising:
a plurality of portlets having a common key of data; and
a system for merging at least two of the plurality of portlets into a merged portlet based on the common key of data.

11. The system of claim 10, wherein the merged portlet comprises a display of data correlated by the common key of data.

12. The system of claim 10, wherein the common key of data comprises a Click-to-Action key.

13. The system of claim 10, wherein the system for merging further comprises:
a system for dragging one of the plurality of portlets to another of the plurality of portlets to initiate the merging.

14. The system of claim 10, wherein the merging occurs automatically.

15. The system of claim 10, wherein the system for merging further comprises:
a system for selecting a command to initiate the merging.

16. The system of claim 10, further comprising:
a system for providing a visual indicator of whether each of the plurality of portlets can be merged.

17. The system of claim 10, wherein the portlets that are merged are located on the same portal page.

18. The system of claim 10, wherein the portlets that are merged are located on different portal pages.

19. A program product stored on a computer readable medium for merging portlets, the computer readable medium comprising program code for performing the steps of:
providing a plurality of portlets having a common key of data; and merging at least two of the plurality of portlets into a merged portlet based on the common key of data.
